(19) United States
(12) Patent Application Publication
(10) Pub. No.: US 2026/0070077 A1
(43) Pub. Date: Mar. 12, 2026

(54) FRAME AND SHELL FOR A TRIGGER HEAD DISPENSING DEVICE

(71) Applicant: GUALA DISPENSING S.P.A., Alessandria (IT)

(72) Inventor: Riccardo ALLUIGI, Alessandria (IT)

(21) Appl. No.: 19/106,479

(22) PCT Filed: Oct. 10, 2023
(86) PCT No.: PCT/IB2023/060150

§ 371 Date: Feb. 25, 2025

(30) Foreign Application Priority Data
Oct. 14, 2022 (IT) 102022000021234

(51) Int. Cl. B05B 11/10; B05B 11/00

(52) U.S. Cl. CPC B05B 11/1057; B05B 11/0039; B05B 11/1064

(57) ABSTRACT

A frame for a trigger head of a dispensing device for a liquid product has a frame base, a cylindrical pressure chamber, an intake duct, an outlet duct, a dispensing duct, and a shoulder consisting of a shoulder wall protruding from a rear zone of the frame base to form a backing for a hand of a user gripping the trigger head while dispensing the liquid product. The shoulder has a rear coupling for a shell of the trigger head.

### FIELD OF THE INVENTION

The present invention is in the field of trigger dispensing devices for the delivery of a product, for example for household hygiene, air freshening, personal hygiene and care, clothing care and the like.

### PRIOR ART

Such devices are enormously popular and appreciated by users for the practicality of use, versatility and, lastly, for the possibility of being used more than once by appropriately refilling the product within the bottle. Several hundred million pieces are produced every year.

To better satisfy the needs of the consumer numerous types of trigger head dispensing devices exist that differ, for example, in the type of dispensable product, the volume of the dispensed product, the type of connection between the trigger dispensing head and the bottle and other further variants.

Every type includes a multiplicity of components, in general designed and manufactured for that specific type. As a result, the manufacturing companies that offer to their clients an ample choice of types, find themselves having to manage innumerably different components, with consequent production, storage, transportation and assembly inconveniences.

The object of the present invention is to meet the needs of the industry and to overcome the drawbacks discussed above with reference to the prior art. In particular, the object of the present invention is that of providing a first type of trigger dispensing head that may be applied by means of a ring nut threaded onto the bottle, and a second type of trigger dispensing head that may be applied by means of a bayonet connection to the bottle, both variants having numerous components in common such as to minimize the overall number thereof.

### OBJECT OF THE INVENTION

The object of the present invention is to meet the needs of the industry and to overcome the drawbacks discussed above with reference to the prior art. In particular, the object of the present invention is that of foreseeing a fist type of trigger dispensing head that may be applied by means of a ring nut threaded onto the bottle, and a second type of trigger dispensing head that may be applied by means of a bayonet connection to the bottle, both that having numerous components in common such as to minimize the overall number thereof.

Such object is achieved by a frame for a trigger dispensing head according to claim 1. The dependent claims disclose further advantageous embodiments of the invention.

### BRIEF DESCRIPTION OF THE DRAWINGS

The features and advantages of the frame according to the present invention will become apparent from the following description, given as a non-limiting example in accordance with the figures in the appended drawings, wherein:

FIG. 1a depicts a trigger dispensing device with a bayonet connection;

FIG. 1b depicts a trigger dispensing device with a threaded connection;

FIG. 2a is a cut-away view of a dispensing head of the trigger dispensing head with the bayonet connection of FIG. 1a;

FIG. 2b is a cut-away view of a dispensing head of the trigger dispensing head with the threaded connection of FIG. 1b;

FIG. 3a depicts a frame of the trigger dispensing head with the bayonet connection of FIG. 2a;

FIG. 3b depicts a frame of the trigger dispensing head with the threaded connection of FIG. 2b;

FIG. 4a is a side view of the frame of FIG. 3a;

FIG. 4b is a side view of the frame 4 FIG. 3b;

FIG. 5 schematically represents the assembly of a shell onto the dispensing head with a bayonet connection and to the dispensing head with a threaded connection;

FIG. 6 shows a shell according to the present invention;

FIG. 7 is a side view of the shell of FIG. 6;

FIG. 8 is a plan view from below of the shell of FIG. 7.

### DESCRIPTION OF A FIRST EMBODIMENT OF THE INVENTION

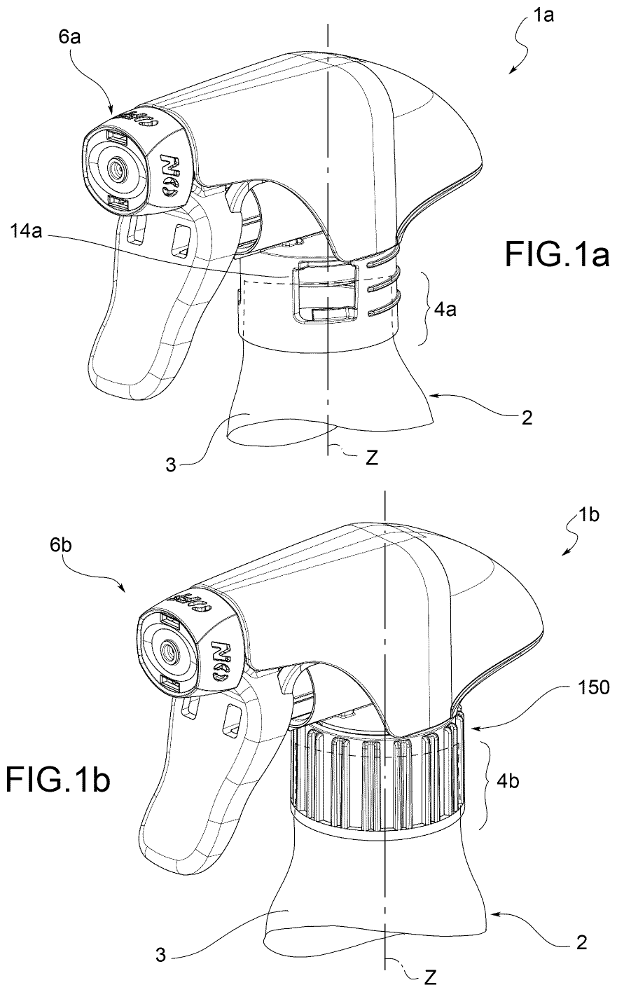

According to one embodiment (FIG. 1a, 2a, 3a, 4a), a trigger dispensing head la comprises a bottle 2, with a neck 4a and having an inner bottle chamber 3 and a trigger dispensing head 6a with a bayonet connection applied to the neck 4a by means of said bayonet connection.

For the bayonet connection the neck 4a has a plurality of neck ridges forming slopes and passages for snap-on coupling to the dispensing head 6a. An exemplary embodiment of a neck for a bayonet connection is shown in the document WO-A1-2019/092517 in the name of the Applicant.

The head 6a comprises a frame 8a for supporting components that are functional to the dispensing of the product and a shell 100 that may be applied to the frame 8a in order to cover it.

### Frame

The frame 8a comprises an annular skirt 10a consisting of a cylindrical skirt wall 12a, having a central axis Z and a predefined axial extension along said central axis Z.

Preferably, the skirt 10a has at least one skirt window 14a, for example a pair of skirt windows 14a, passing through the thickness of the skirt wall 12a, that are preferably symmetrical.

The skirt 10a furthermore comprises at least one flexible fin 16a for the snap-on insertion onto a neck 4a and engagement with the neck ridges of the neck 4a of the bottle 2. Preferably, three fins 16a are envisaged, angularly spaced apart, preferably arranged at the lower edge of a respective skirt window 14a.

The frame 8a furthermore comprises a frame base 18 extending substantially orthogonal to the central axis Z, wherefrom the skirt 10a protrudes at the bottom.

The frame 8a furthermore comprises an annular sealing wall 20a, coaxial to the skirt wall 12a, protruding axially at the bottom from the frame base 18, radially internal to the skirt wall 12a and to the fins 16a, in order to form a liquid seal when the head 6a is applied to the neck 4a of the bottle 2.

The frame 8a furthermore comprises an intake tube 22, protruding axially at the bottom from the frame base 18, for example offset in relation to the central axis Z and preferably a breather tube 24a, protruding axially at the bottom from the frame base 18, for example offset in relation to the central axis Z.

Within the frame 8a there is furthermore obtained a cylindrical pressure chamber 26 having a chamber axis X orthogonal to the central axis Z, annularly delimited by a chamber wall 28, supported by the frame base 18. At the front, the pressure chamber 26 has an opening 26′ for a piston; at the back, the pressure chamber 26 is delimited by a chamber bottom 26″.

Within the frame 8a there is furthermore obtained an intake duct 30 for placing the bottle chamber 3 in fluidic communication with the pressure chamber 26; for example, the intake duct 30 comprises a vertical intake section 32, parallel to the central axis Z, that extends at least in part, into the intake tube 22 and that emerges into the bottle chamber 3, and a horizontal intake section 34, parallel to the chamber axis X, connected to the vertical intake section 32 and that emerges into the pressure chamber 26.

Within the frame 8a there is furthermore obtained a dispensing duct 36 for dispensing the product into the external environment, having an extension along a dispensing axis Y, spaced apart and parallel to the chamber axis X, between an inner end 38 and an outer end 40 for the dispensing of the product. The dispensing duct 36 is delimited by an annular dispensing wall 37 having an extension along the dispensing axis Y.

The chamber axis X and the dispensing axis Y lie on the same imaginary sagittal plane Ps of the frame 8a and/or of the dispensing head 1a; preferably, the central axis Z also lies on said sagittal plane Ps.

Within the frame 8a there is furthermore obtained an outlet duct 42 for placing the pressure chamber 26 in fluid communication with the dispensing duct 36; for example, the outlet duct 42 comprises a horizontal outlet section 44, parallel to the chamber axis X, that emerges into the pressure chamber 26, and a vertical outlet section 46, parallel to the central axis Z, connected to the horizontal outlet section 44 and to the inner end 38 of the dispensing duct 36.

The vertical outlet section 46 has, furthermore, an outlet extension 48, projecting above the dispensing wall 37, delimited by an outlet tube 50.

The frame 8a furthermore comprises a shoulder 52 consisting of a shoulder wall 54, which protrudes at the back from a rear zone of the frame base 18 to form a backing for the hand of a user who is gripping the dispensing head while dispensing the product.

In particular, the shoulder wall 54 has a preferably arched lower face 56, whereagainst rests the zone of the hand between thumb and forefinger, and an opposite upper face 58.

The shoulder 52 comprises a rear coupling 60 for the shell 100 of the head 1a, preferably consisting of a hook wall 62, projecting above from the upper face 58, for example with a tooth 64, and a facing wall 66, projecting above from the upper face 58, facing the hook wall 62 and flexible to make a snap-on connection to the shell 100.

Preferably, furthermore, the shoulder 52 comprises a rear support 68 consisting of support wall 70 protruding above from the upper face 58 of the shoulder wall 54, to make a support for the shell 100.

The frame 8a furthermore comprises an intermediate coupling 72 for the shell 100, supported by the dispensing wall 37, thereabove, arranged at the inner end 38 of the dispensing duct 36, preferably in front of the outlet tube 50. Preferably, the intermediate coupling 72 consists of a hook wall 74, projecting above from the dispensing wall 37, and a facing wall 76, projecting above from the dispensing wall 37, facing the hook wall 74 and flexible to make a snap-on connection to the shell 100.

The outlet tube 50 is arranged between the rear coupling 60 and the intermediate coupling 72 protruding from the dispensing wall 37, thereabove.

Preferably, furthermore, the frame 8a comprises an intermediate support 78 for the shell 100, supported by the dispensing wall 37, thereabove, arranged between the inner end 38 and the outer end 40 of the dispensing duct 36, preferably in front of the intermediate coupling 72. For example, the intermediate support 78 comprises a cross-shaped support wall 80.

The frame 8a furthermore comprises a front coupling 82 for the shell 100, supported by the dispensing wall 37, thereabove, arranged at the opening 26′ of the pressure chamber 26, preferably in front of the intermediate support 78.

Preferably, the front coupling 82 comprises a pair of couplings 84, protruding above from the dispensing wall 37, arranged symmetrically in relation to the sagittal plane Ps of the frame 8a. Preferably, the coupling 84 consists of a hook wall 86, for example lying on the sagittal plane Ps, and a facing wall 88′, 88″, protruding above from the dispensing wall 37, facing the hook wall 84 and flexible to make a snap-on connection to the shell 100. The two hook walls 88′, 88″ are therefore facing therebetween and parallel, and on the opposite side of the sagittal plane Ps.

Preferably, furthermore, the frame 8a comprises a front support 90 for the shell 100, supported by the dispensing wall 37, thereabove, arranged at the outer end 40 of the dispensing duct 36, preferably in front of the front coupling 82. For example, the front support 90 constitutes a support wall 92 lying on an imaginary plane orthogonal to the dispensing axis Y.

Preferably, the frame 8a is made as one piece from a plastic material, for example using a polyolefin polymer material, for example polypropylene (PP) or recycled polypropylene (rPP), for example by injection molding.

### Shell

The shell 100 consists of a thin wall that forms a casing that covers the dispensing wall 37, the pressure chamber 26 with the relative chamber wall 28, and the shoulder 52 up to the frame base 18. The skirt 10a instead remains uncovered.

The shell 100 is generally symmetrical in relation to the sagittal plane Ps and consists of a front cover 101 that straddles the dispensing duct 36a and that is formed by a right front wall 102 and a left front wall 104, which join at the top, and a rear cover 103 arranged above the shoulder 52 and that is formed by a right rear wall 106 and a left rear wall 108, which join at the top. The rear cover 103 joins at the front with the rear edge of the front cover 101.

The front cover 101 covers, laterally and above, the dispensing wall 37 and the pressure chamber 26; the rear cover 103 covers the shoulder 52 above.

The shell 100 comprises a rear counter-coupling 160 adapted to make a snap-on connection to the rear coupling 60 of the frame 8a, protruding internally from the rear cover 103. For example, the rear counter-coupling 160 comprises a hook counter-wall 162 ending in a blunt counter-tooth 164, for facilitated snap-in insertion between the hook wall 62 and the facing wall 66 of the rear coupling 60 of the shoulder 52. Preferably, the hook counter-wall 162 is orthogonal to the central axis Z, for example symmetrical in relation to the sagittal plane Ps.

Preferably, furthermore, the shell 100 comprises a rear counter-support 168, protruding internally from the rear cover 103, preferably conforming to a step, to rest on the rear support 68 of the shoulder 52.

The shell 100 furthermore comprises a cap element 151 adapted to make a cap for an outlet tube 50 of the frame 8a, protruding internally from the front cover 101. For example the cap element 151 constitutes a tube cap 153 that is open at the open end and closed at the bottom by a cap region 155 of the shell 100, in particular of the front cover 101. Preferably, the cap element 151 is symmetrical in relation to the sagittal plane Ps.

The shell 100 furthermore comprises an intermediate counter-coupling 172 adapted to make a snap-on connection to the intermediate counter-coupling 172 of the frame 8a, protruding internally from the front cover 101. For example, the intermediate counter-coupling 172 constitutes a hook counter-wall 174 terminating in a blunt counter-tooth 175 for facilitated snap-in insertion between the hook wall 74 and the facing wall 76 of the intermediate coupling 72 of the shoulder 52. Preferably, the hook counter-wall 174 is orthogonal to the central axis X, for example asymmetrical in relation to the sagittal plane Ps.

The shell 100 furthermore comprises a front counter-coupling 182 adapted to make a snap-on connection to the front coupling 82 of the frame 8a, protruding internally from the front cover 101, in front of the intermediate counter-coupling 172.

Preferably, the front counter-coupling 182 comprises a pair of counter-couplings 184, arranged symmetrically in relation to the sagittal plane Ps. Each counter-coupling 184 constitutes a hook counter-wall 186 terminating in a blunt counter-tooth 187 for facilitated snap-in insertion between the hook wall 86 and the facing wall 88′, 88″ of the coupling 84 of the frame 8a. Preferably, hook counter-walls 186 are facing therebetween and parallel and on the opposite side of the sagittal plane Ps.

Preferably, the shell 100 is made as one piece from a plastics material, for example using a polyolefin polymer material such as polypropylene (PP) or recycled polypropylene (rPP).

### Other Components

The head 6a furthermore comprises a piston 122 sliding sealed within the pressure chamber 26, along said chamber axis X. Preferably, the piston 122 is made as one piece from a plastic material, for example using a polyolefin polymer material such as polypropylene (PP), recycled polypropylene (rPP) or high-density polyethylene (HDPE).

The head 6a furthermore comprises the trigger 124, adapted for being manually actuated, preferably applied to the frame 8a and operationally connected to the piston 122 in order to actuate it in translation within the pressure chamber 26.

The head 6a furthermore comprises elastic return means that are suitable for permanently biasing the piston 122 towards the initial position. Preferably, said return means comprise a flexible return portion of the trigger 124. In other words, the return means are integrated into the trigger 124. Preferably, the trigger 124 is made as one piece from a plastic material, for example using a polyolefin polymer material such as polypropylene (PP) or recycled polypropylene (rPP).

The head 6a furthermore preferably comprises a nozzle 126 that is either fixed or rotating, and that is applied to the free end of the dispensing pipe 36 for modifying the spray patterns of the dispensed jet or for allowing the dispensing pipe to be closed in order to impede the dispensing of the product. Preferably, the nozzle 126 is made as one piece from a plastics material, for example using a polyolefin polymer material such as polypropylene (PP).

The head 6a further comprises valve means suitable for adjusting the product flow from the bottle compartment to the pressure chamber and from the pressure chamber to the external environment. Preferably, said valve means comprise a valve body 140 made as one piece, for example from a polyolefin polymer material, for example, low-density polyethylene (LDPE) or Ethylene Thermoplastic Octene (TPEO), obtained by means of injection molding, housed within the pressure chamber 26 at the chamber bottom 26″, in order to cooperate with the intake duct 30 and with the outlet duct 42.

### Head Assembly

The assembly of the trigger head is preferably completely automatic and includes, in succession, the machine loading of the frame, mounting the valve body into the pressure chamber, mounting the piston to the frame, mounting the trigger to the frame, mounting the nozzle to the frame, mounting the shell to the frame.

The shell 100 may be applied vertically to the frame 8a, that is to say by means of parallel translation to the central axis Z.

When the shell 100 is applied to the frame 8a:
the rear counter-coupling 160 of the shell 100 is coupled to the rear coupling 60 of the frame 8a; in particular, the hook counter-wall 162 is snap-on inserted between the hook wall 62 and the facing wall 66 of the shoulder 52;
the cap element 151 of the shell 100 is coupled to the outlet tube 50 of the frame 8a in order to close it; in particular, the tube cap 153 is inserted into the outlet tube 50;
the intermediate counter-coupling 172 of the shell 100 is coupled to the intermediate coupling 72 of the frame 8a; in particular, the hook counter-wall 174 is snap-on inserted between the hook wall 74 and the facing wall 76 of the frame 8a;
the front counter-coupling 182 of the shell 100 is coupled to the front coupling 82 of the frame 8a; in particular, the hook counter-wall 186 of the shell 100 is snap-on inserted between the hook wall 86 and the respective facing wall 88′, 88″ of the frame 8a.

Consequently, the shell 100 is supported by the frame 8a, insofar as:
the rear counter-support 168 of the shell 100 rests on the rear support 68 of the shoulder 52;
an intermediate region 78′ of the shell 100, arranged between the intermediate counter-coupling 172 and the front counter-coupling 182, rests on the intermediate support 78 of the frame 8a;
a front region 90′ of the shell 100, arranged in front of the front counter-coupling 182, rests on the front support 90 of the frame 8a.

### Description of a Preferred Embodiment of the Invention

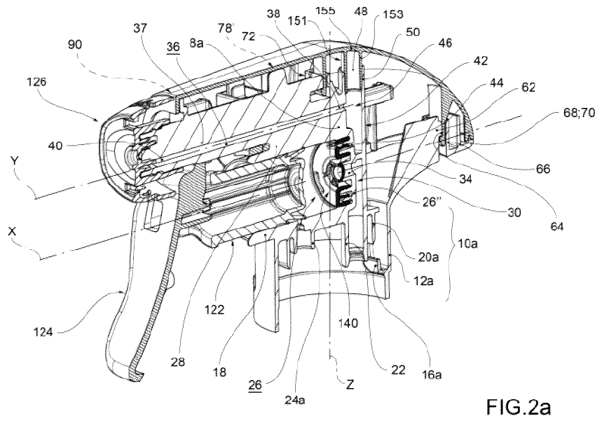

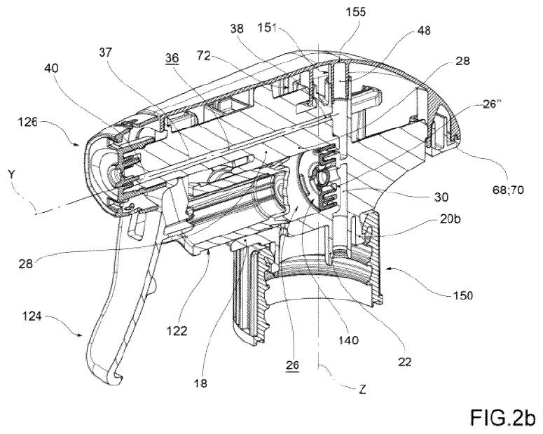

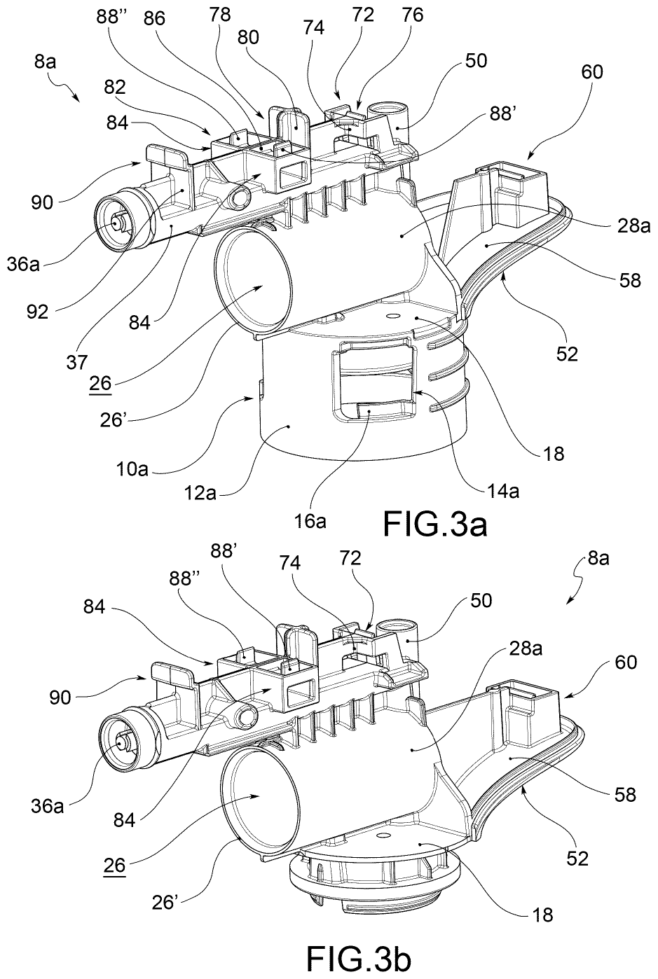

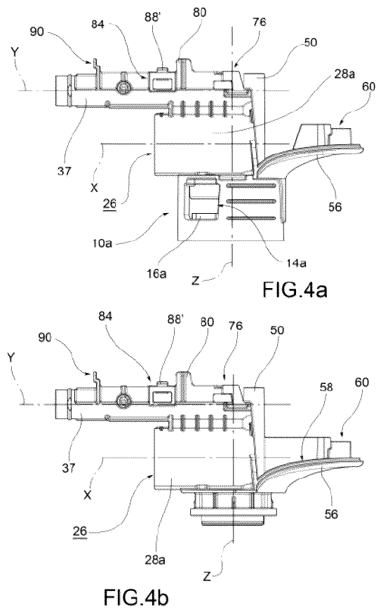

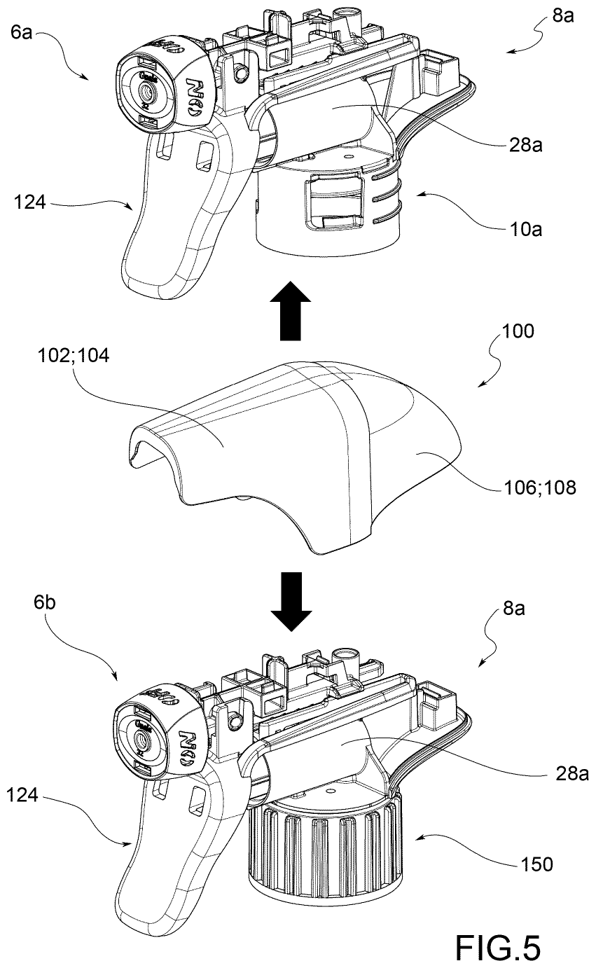

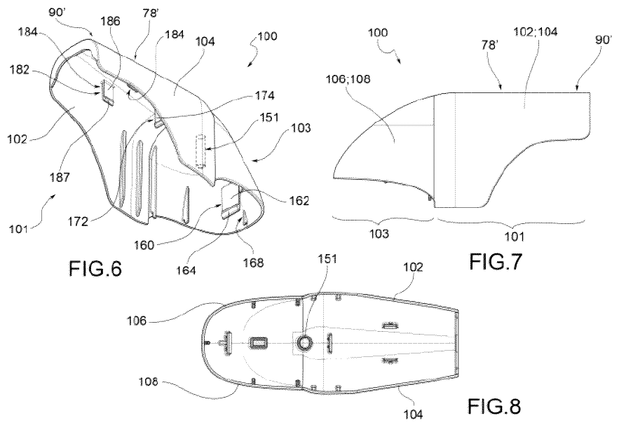

According to a further embodiment (FIGS. 1b, 2b, 3b, 4b), a trigger dispensing head 1b comprises a bottle 2, with a neck 4b and having an inner bottle chamber 3 and a trigger dispensing head 6b with a threaded connection applied to the neck 4b by means of said threaded connection.

For the threaded connection, the neck 4b has an outer thread for the screwing of a ring nut 150 of the head 6b. The ring nut 150 may be screwed by rotation about a central axis Z.

The head 6b comprises a frame 8b for supporting components that are functional to the dispensing of the product. The frame 8b comprises a frame base 18 extending substantially orthogonal to the central axis Z.

The frame 8b furthermore comprises an annular peripheral sealing wall 20b, coaxial to the central axis Z, protruding axially at the bottom from the frame base 18, whereto the ring nut 150 is coupled.

In an embodiment variant (not shown), the frame 8b comprises a second annular sealing wall, internal to the first, coaxial to the central axis Z, to make a head seal on the neck of the bottle.

The frame 8b furthermore comprises an intake tube 22b, protruding axially at the bottom from the frame base 18, for example offset in relation to the central axis Z.

Other than the features described herein, the frame b is structurally and functionally identical to the frame 8a of the bayonet connection head 1a. In particular, the frame 8b for the head 1b with a threaded connection is devoid of the skirt 10a.

The other components described for the bayonet connection head 1a are also structurally and functionally identical to the respective components of the head 1b with the threaded connection: the shell 100, the piston 122, the trigger 124, the nozzle 126, the valve body 140.

The assembly of the head 1b with the threaded connection takes place as described above for the bayonet connection head la, furthermore including the mounting of the ring nut to the frame.

### O

Innovatively, the invention satisfies the needs of the sector and overcomes the aforementioned disadvantages, insofar as the same components, excluding the frame, and the same assembly line are used to make a bayonet connection head or else a head with a threaded connection. This leads to a reduction in the number of overall components and the use of the same assembly line.

Advantageously, furthermore, the dispensing head according to the present invention has a high degree of recyclability insofar as 98% by weight of the components used may molded from PP; the main valve body may instead be molded from LDPE or TPEO, but the weight is so contained that the head may be considered to be a single material, according to industry regulations.

Furthermore, advantageously, the heavier components, that is to say the trigger, the piston, the nozzle, the frame, the shell and the ring nut, which together constitute 70% of the weight of the head, may be molded from recycled polypropylene (rPP).

Advantageously, furthermore, the weight of the head, according to the present invention, is extremely contained, which the Applicant has estimated to be about 20% less than similar devices on the market.

It is clear that a person skilled in the art could make changes to the dispensing head, and in particular the main body of the valve means, with the aim of satisfying contingent needs. Such modifications are contained within the scope of protection as defined by the following claims.

1-27. (canceled)

28. A frame for a trigger head of a dispensing device for a liquid product, comprising:
a frame base orthogonal to a central axis;
a cylindrical pressure chamber having a chamber axis orthogonal to the central axis, annularly delimited by a chamber wall, above the frame base, the cylindrical pressure chamber having an opening at a front thereof and a chamber bottom at a back thereof;
an intake duct, an outlet duct and a dispensing duct having an extension along a dispensing axis, spaced from and parallel to the chamber axis and delimited by a dispensing wall; and
a shoulder consisting of a shoulder wall, which protrudes at the back from a rear zone of the frame base to form a backing for a hand of a user gripping the trigger head while dispensing the liquid product,
wherein the shoulder comprises a rear coupling for a shell of the trigger head adapted to make a snap-on connection with the shell,
wherein the shoulder wall has an arched lower face adapted to support a zone of the hand of the user between a thumb and a forefinger, and an opposite upper face,
wherein the rear coupling consists of a hook wall projecting above from the upper face, and a facing wall projecting above from the upper face, facing the hook wall and flexible to make the snap-on connection with the shell, and
wherein the shoulder further comprises a rear support behind the rear coupling for making a support for the shell.

29. The frame of claim 28, wherein the rear support consists of a support wall protruding above from the upper face of the shoulder wall.

30. The frame of claim 28, further comprising an outlet tube delimiting an extension of the outlet duct, arranged in front of the rear coupling.

31. The frame of claim 30, further comprising an intermediate coupling for the shell, arranged in front of the outlet tube, adapted to make a snap-on connection with the shell.

32. The frame of claim 31, further comprising an intermediate support for making a support for the shell, arranged in front of the intermediate coupling.

33. The frame of claim 31, further comprising a front coupling for the shell, arranged in front of the intermediate coupling, adapted to make a snap-on connection with the shell.

34. The frame of claim 33, further comprising a front support for making a support for the shell, arranged in front of the front coupling.

35. The frame of claim 28, wherein the frame is made in one-piece of plastic material, optionally the plastic material being polyolefin polymer material.

36. The frame of claim 28, further comprising an annular skirt consisting of a cylindrical skirt wall protruding at the bottom from the frame base, coaxial to the central axis, internally comprising at least one flexible fin for snap-on insertion onto a neck of a bottle of the dispensing device.

37. The frame of claim 36, wherein the annular skirt comprises at least one skirt window passing through a thickness of the cylindrical skirt wall, the at least one flexible fin being arranged at a lower edge of the at least one skirt window.

38. The frame of claim 34, wherein the chamber axis and the dispensing axis lie on an imaginary sagittal plane of the frame, wherein the front coupling comprises a pair of couplings protruding above from the dispensing wall and arranged symmetrically in relation to the imaginary sagittal plane.

39. The frame of claim 38, wherein each coupling of the pair of couplings consists of a hook wall and a facing wall protruding above from the dispensing wall, facing the hook wall and flexible to make a snap-on connection with the shell.

40. The frame of claim 39, wherein the hook wall lies on the imaginary sagittal plane.

41. A trigger head for a dispensing device for a liquid product, comprising:
the frame of claim 28; and
a shell comprising a front cover formed by a right front wall and a left front wall, which join at the top, and a rear cover formed by a right rear wall and a left rear wall, which join at the top and at the rear,
wherein the rear cover joins at the front with a rear edge of the front cover, and
wherein the shell comprises a rear counter-coupling snap-on connected to the frame, protruding internally from the rear cover.

42. The frame of claim 35, wherein the polyolefin polymer material is polypropylene (PP) or recycled polypropylene (rPP).
